(19) United States
(12) Patent Application Publication
(10) Pub. No.: US 2024/0208429 A1
(43) Pub. Date: Jun. 27, 2024

(54) LIFT FOR A TRANSPORT RACK

(71) Applicant: Carl O. Whited, Jr., Perris, CA (US)

(72) Inventor: Carl O. Whited, Jr., Perris, CA (US)

(21) Appl. No.: 18/393,229

(22) Filed: Dec. 21, 2023

Related U.S. Application Data
(60) Provisional application No. 63/476,706, filed on Dec. 22, 2022.

(51) Int. Cl. B60R 9/06; B66F 3/02

(52) U.S. Cl. CPC B60R 9/06; B66F 3/02

(57) ABSTRACT

A lift includes a frame configured to be removably coupled to a hitch of a vehicle. The lift also includes a lift structure adapted to be coupled to a transport rack and movably coupled to the frame. The lift structure is configured to move in a vertical direction between a raised position and a lowered position relative to the frame. Moreover, the lift structure is moved to the lowered position to enable a loading and an unloading of a cargo from the transport rack.

### CROSS-REFERENCE TO RELATED APPLICATIONS

This application claims the benefit of U.S. Provisional Patent Application No. 63/476,706, filed on Dec. 22, 2022, the teachings of which are expressly incorporated by reference.

### STATEMENT RE: FEDERALLY SPONSORED RESEARCH/DEVELOPMENT

NOT APPLICABLE

### BACKGROUND

The present disclosure pertains to a lift for facilitating a loading of bikes on a rack. More particularly, the present disclosure pertains to a lift adapted to couple a rack with a transport vehicle and facilitates a loading of a cargo on the rack coupled to the transport vehicle.

To transport a cargo, such as, heavy e-bikes, the bike racks that attach to a receiving hitch of a truck or other similar vehicle, are generally used. However, loading the e-bikes on the rack is difficult as the bikes are to be lifted on to the rack, which is undesirable.

### SUMMARY

One aspect of this disclosure relates to a lift is disclosed. The lift includes a frame configured to be removably coupled to a hitch of a vehicle, and a lift structure adapted to be coupled to a transport rack and movably coupled to the frame. The lift structure is configured to move in a vertical direction between a raised position and a lowered position relative to the frame. The lift structure is moved to the lowered position to enable a loading and unloading of a cargo from the transport rack.

In some additional, alternative, or selectively cumulative embodiments, the frame includes at least one column extending in the vertical direction and the lift structure is movably coupled to the at least one column. The frame also includes an arm extending perpendicularly to the at least one column and configured to be removably coupled to the hitch of the vehicle.

In some additional, alternative, or selectively cumulative embodiments, the arm defines at least one hole to facilitate the removable coupling of the arm with the hitch of the vehicle.

In some additional, alternative, or selectively cumulative embodiments, the at least one column includes a first column and the arm is attached to the first column, and a second column attached to the first column and extending parallel to the first column. The lift structure is telescopically coupled to the second column and is adapted to extend and retract relative to second column between the raised position and the lowered position.

In some additional, alternative, or selectively cumulative embodiments, the lift structure includes a post extending in the vertical direction and movably coupled to the at least one column, and an elongated bar extending perpendicularly to the post and configured to engage with the transport rack to facilitate the coupling of the lift and the transport rack.

In some additional, alternative, or selectively cumulative embodiments, the elongated bar defines at least one opening to facilitate the engagement of the elongated bar with the transport rack.

In some additional, alternative, or selectively cumulative embodiments, the lift further comprises a pair of extendable ratchet straps attached to the lift structure and a pair of hooks attached to the pair of ratchet straps.

In some additional, alternative, or selectively cumulative embodiments, the lift further comprises an actuator assembly configured to move the lift structure between the raised position and the lowered position.

In some additional, alternative, or selectively cumulative embodiments, the actuator assembly includes an actuator and a lift mechanism coupled to the lift structure and operated by the actuator to move the lift structure between the raised position and the lowered position.

In some additional, alternative, or selectively cumulative embodiments, the actuator includes an electric motor, and the lift further includes a battery configured to power the electric motor.

In some additional, alternative, or selectively cumulative embodiments, the lift further comprises an on-off switch to electrically connect and disconnect the electric motor and the battery.

In some additional, alternative, or selectively cumulative embodiments, the lift further comprises a direction control switch adapted to be displaced between a first position and a second position to control a direction of rotation of the electric motor.

In accordance with another example embodiment, a transport rack assembly is disclosed. The transport rack assembly includes a transport rack having a loading structure adapted to support a cargo and an engagement structure, and a lift removably coupled to the transport rack. The lift includes a frame configured to be removably coupled to a hitch of a vehicle and a lift structure removably coupled to the engagement structure of the transport rack. The lift structure is movably coupled to the frame. Moreover, the lift structure is configured to move in a vertical direction between a raised position and a lowered position relative to the frame. Furthermore, the lift structure is moved to the lowered position to enable a loading and unloading of the cargo from the transport rack.

In some additional, alternative, or selectively cumulative embodiments, the frame includes at least one column extending in the vertical direction, and the lift structure is movably coupled to the at least one column. The frame also includes an arm extending perpendicularly to the at least one column and configured to be coupled to the hitch of the vehicle.

In some additional, alternative, or selectively cumulative embodiments, the at least one column includes a first column and the arm is attached to the first column, and a second column attached to the first column and extending parallel to the first column. The lift structure is telescopically coupled to the second column and is adapted to extend and retract relative to second column between the raised position and the lowered position.

In some additional, alternative, or selectively cumulative embodiments, the lift structure includes a post extending in the vertical direction and movably coupled to the at least one column, and an elongated bar extending perpendicularly to the post and configured to engage with the engagement structure to facilitate the removable coupling of the lift and the transport rack.

In some additional, alternative, or selectively cumulative embodiments, the lift further comprises a pair of extendable ratchet straps attached to the lift structure and a pair of hooks attached to the pair of ratchet straps.

In some additional, alternative, or selectively cumulative embodiments, the lift further comprises an actuator assembly configured to move the lift structure between the raised position and the lowered position.

In some additional, alternative, or selectively cumulative embodiments, the actuator assembly includes an actuator and a lift mechanism coupled to the lift structure and operated by the actuator to move the lift structure between the raised position and the lowered position.

In some additional, alternative, or selectively cumulative embodiments, the lift further comprises a direction control switch adapted to be displaced between a first position and a second position to control a direction of movement of the actuator.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts a perspective view of a transport rack assembly having a rack and a lift engaged with the vehicle and the rack, in accordance with an embodiment of the disclosure;

FIG. 2 depicts the lift of FIG. 1 removed from the vehicle, in accordance with an embodiment of the disclosure; and

FIG. 3 illustrates a front view of a lift with some of the components removed, in accordance with another embodiment of the disclosure.

### DETAILED DESCRIPTION

The detailed description set forth below is intended as a description of the presently preferred embodiment of the disclosure, and is not intended to represent the only form in which the present disclosure may be constructed or utilized. The description sets forth the functions and sequences of steps for constructing and operating the disclosure. It is to be understood, however, that the same or equivalent functions and sequences may be accomplished by different embodiments and that they are also intended to be encompassed within the scope of the disclosure.

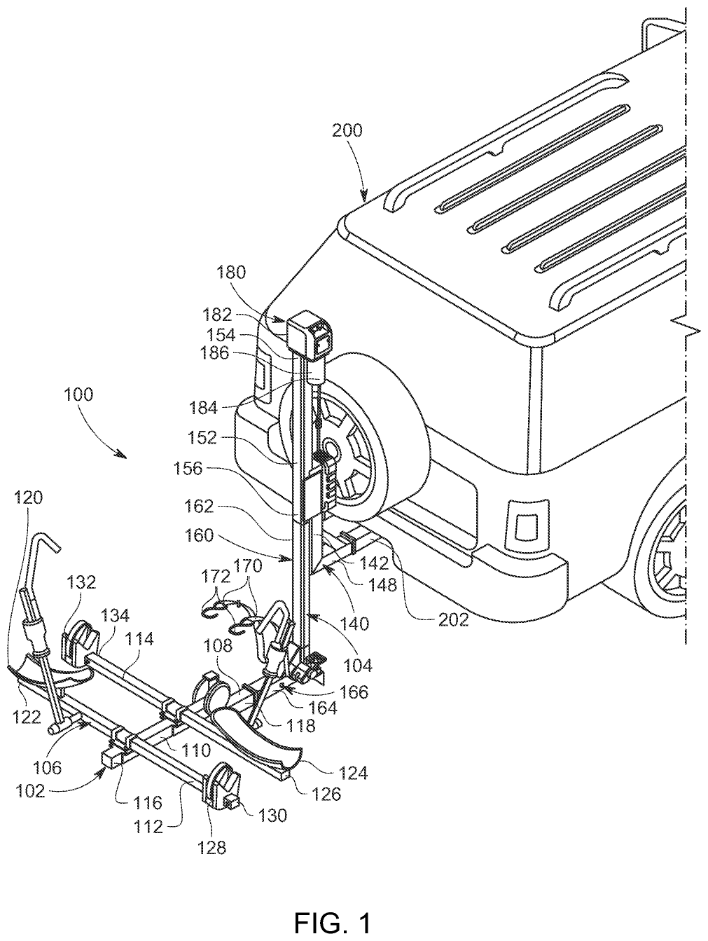

Referring to FIG. 1, a perspective view of a transport rack assembly 100 coupled to a vehicle 200 and extending rearwardly of the vehicle 200 is shown. As shown, the transport rack assembly 100 includes a transport rack 102 to support a cargo, for example, one or more bikes, and a lift 104 removably coupled to both the rack 102 and the vehicle 200. Accordingly, the lift 104 is arranged between the vehicle 200 and the rack 102 in an engagement of the rack assembly 100 with the vehicle 200. In an embodiment, the vehicle 200 may be a transport vehicle, for example, a truck, or any other vehicle, such as, but not limited to, a car, a jeep, a two-wheeler, a sport utility vehicle, a multi-utility vehicle, etc., suitable to pull the rack 102.

Referring to FIG. 1, the transport rack 102 (i.e., rack 102) includes a loading structure 106 configured to support the at least one cargo and an engagement structure 108 configured to be engaged with the lift 104. In the illustrated embodiment, the engagement structure 108 includes at least one beam 110, while the loading structure 106 includes at least one cross-member, for example, a first cross-member 112 and a second cross-member 114, supported on the beam 110 and extending substantially perpendicularly to the beam 110. As shown, the cross-members 112, 114 are disposed substantially parallel to each other and are arranged proximate to a first end 116 of the beam 110. Further, a second end 118 of the beam 110 extends outwardly of the second cross-member 114 and is configured to engage with the lift 104. Further, to support the cargo on the cross-members 112, 114 and secure the cargo with the cross-members 112, 114, the loading structure 106 includes a plurality of brackets, for example, a first arcuate bracket 120 attached to a first lateral end 122 of the first cross-member 112 and a second arcuate bracket 124 attached to a first lateral end 126 of the second cross-member 114. Additionally, the plurality of brackets includes a first V-shaped bracket 128 attached to a second lateral end 130 of the first cross-member 112, and a second V-shaped 132 bracket attached to a second lateral end 134 of second cross-member 114. Although the loading structure 106 is shown to include the cross-members 112, 114 and the brackets 120, 124, 128, 132, it may be envisioned that the rack 102 may include any other type of loading structure known in the art.

Further, the rack 102 includes a plurality of wheels (not shown) coupled to the loading structure 106 and adapted to facilitate a movement of the rack 102 (i.e., rack assembly 100) over a surface. To facilitate a removable coupling of the rack 102 with the lift 104, the beam 110 may define at least one hole (not shown) extending through a width of the beam 110 and disposed proximate to the second end 118 of the beam 110.

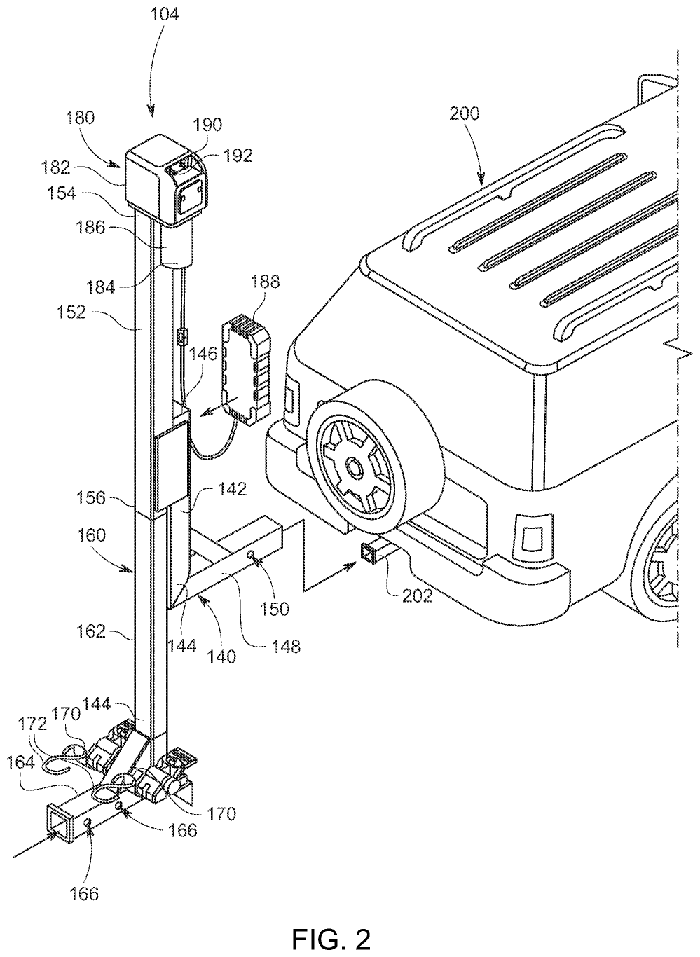

Referring to FIGS. 1 and 2, the lift 104 includes a frame 140 having at least one column, for example, a first column 142, extending vertically and having a bottom end 144 (i.e., first end 144) and a top end 146 (i.e., second end 146) and an arm 148 arranged at the bottom end 144 of the first column 142 and extending substantially perpendicularly in a horizontal direction relative to the first column 142. Accordingly, the first column 142 and the arm 148 together define an L shaped structure and acts as support structure for other component of the lift 104. Further, arm 148 defines at least one hole 150 that facilitates the coupling/engagement of the lift 104 with a hitch 202 of the vehicle 200. Although a single hole 150 is shown and contemplated, it may be envisioned that the arm 148 may define a plurality of holes arrayed along a length of the arm 148. In an assembly of the lift 104 with the hitch 202, arm 148 extends inside the hitch 202, as shown in FIG. 1.

In some embodiments, the lift 104 may include a swing mechanism (not shown) that facilitates in swinging of the arm 148 in a lateral direction relative to the vehicle 200 when the arm 148 is engaged to the hitch 202 of the vehicle 200. Additionally, the frame 140 includes a second column 152 extending substantially parallel to the first column 142 and coupled to the first column 142. As shown, the second column 152 is arranged side by side with the first column 142 and includes a top end 154 arranged vertically above the top end 146 of the first column 142 and a bottom end 156 arranged vertically above the bottom end 144 of the first column 142. Further the second column 1452 is a hollow tube having an opening arranged at the bottom end 156.

Further, the lift 104 includes a lift structure 160 movably coupled to the frame 140 and adapted to move vertically relative to the frame 140 between a raised position and a lowered position. In the illustrated embodiment, the lift structure 160 is telescopically coupled to the second column 152 and configured to telescopically extend and retract relative to the second column 152. As shown, the lift structure 160 includes a post 162 extending in a vertical direction and operatively i.e., telescopically, coupled with the second column 152, and an elongated bar 164 extending in a horizontal direction from a lower end of the post 162 and arranged substantially perpendicularly to the post 162.

As shown in FIGS. 1 and 2, the elongated bar 164 extends in a direction opposite to the extension of the arm 148 from the first column 142. Also, the post 162 is arranged on a side opposite to the extension of the arm 148 from the first column 142. The elongated bar 164 is adapted to couple with the rack 102 i.e., the beam 110, and defines at least one opening 166, for example, two openings 166 arrayed along a length of the bar 164. The openings 166 facilitate the removable coupling/engagement of the lift 104 with the engagement structure 108 (i.e., beam 110) of the rack 102. To enable the coupling of the bar 164 with the beam 110, the beam 110 is inserted inside the bar 164 such that the at least one hole of the beam 110 aligns with the at least one opening 166 of the bar 164, and a pin is inserted through the aligned opening 166 and the hole of the beam 110. The lift 104 further includes a pair of extendable ratchet straps 170 with a pair of hooks 172 arranged on either side the post 162 and supported/coupled to the bar 164 to secure the cargo on the rack 102.

To move the lift structure 160 between the lowered position and the raised position, the lift 104 includes an actuator assembly 180. In an embodiment, the actuator assembly 180 may include a lift mechanism 182, and an actuator 184 to drive or operate the lift mechanism 182. In an embodiment, the actuator 184 may include an electric motor 186, and the lift mechanism 182 may include a rack and pinion arrangement. In such a case, a pinion may be coupled to the electric motor 186, which in turn rotates the pinion and is fixedly supported/mounted to the second column 152 i.e., the frame 140, and a rack that may be fixedly attached to the post 162 of the lift structure 160. Accordingly, the motor 186 is rotated in a first direction to lower the lift structure 160 relative to the frame 140, and is rotated in a second direction to raise the lift structure 160 relative to the frame 140. Accordingly, the post 162 telescopically extends outwardly of the second column 152 when the motor 186 is rotated in the first direction, while the post 162 retracts inside the second column 152 when the motor 186 is rotated in the second direction. To provide electrical power to the electric motor 186, the lift 104 may include a battery 188.

Although the rack and pinion arrangement is contemplated as the lift mechanism 182, it may be envisioned that any other similar mechanism, for example, a worm wheel assembly may also be utilized. In some embodiments, the lift mechanism 182 may include a screw drive type actuator configuration. In some embodiment, the actuator assembly 180 may include a cylinder having a cylindrical casing connected to the second column 152 (i.e., frame 140) and a piston connected to the lift structure 160. In such a case, the lift structure 160 is raised and lowered by extending and retracting the piston relative to the cylindrical casing. In some embodiments, the cylinder may be hydraulically operated or pneumatically operated. Also, it may be envisioned that the scope of the lift 104 of the present disclosure is not limited by the type of actuator assembly, and any suitable actuator assembly configured to move the lift structure 160 relative to the frame 140 between the lowered position and the raised position can be utilized.

In some embodiments, each of the columns 142, 152, the arm 148, the post 162, and the elongated bar 164, includes a tube or a shaft having square cross-section. However, it may be appreciated that the columns 142, 152, the arm 148, the post 162, and the elongated bar 164, each may include any other suitable cross-section, such as, but not limited to, circular, elliptical, trapezoidal, rectangular, etc., known in the art, and the scope of the disclosure is not limited by the shape or cross-section of the components.

Moreover, the lift 104 may include at least one switch, for example, an ON-OFF switch 190 to electrically connect and disconnect the battery 188 and the motor 186. Also, the lift includes a direction control switch 192 adapted to be displaced between a first position and a second position. The motor 186 is adapted to rotate in the first direction when the switch 192 is moved to the first position, while the motor 186 rotates in the second direction opposite to the first direction when the switch 192 is arranged at the second position.

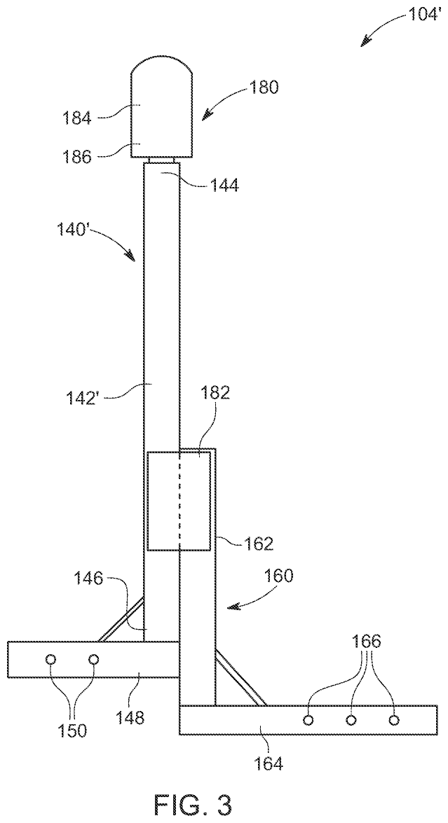

Referring to FIG. 3, a front view of a lift 104′ according to another embodiment is shown. The lift 104′ is similar to the lift 104 except that a frame 140′ of the lift 104′ is different from the frame 140 of the lift 104 in that the second column 152 is omitted from the frame 140′. In such a case, the actuator 184 i.e., motor 186 is mounted to a first column 142′ of the frame 140′. To move the lift structure 160 between the lowered position and the raised position relative to the frame 140′, the motor 186 is rotated in the first direction and the second direction similar to the lift 104. It may be appreciated that some of the components of the lift 104′ are not shown in FIG. 3 for the sake of simplicity.

A method of loading a cargo, for example, bikes, on the rack 102 for transportation of the cargo from one location to another location is now described. The method includes coupling the lift 104, 104′ with the vehicle 200 by engaging the frame 140, 140′ of the lift 104, 104′ with the hitch 202 of the vehicle 200. For so doing, in an embodiment, a suitable engagement structure is inserted through a suitable hole 150 of the arm 148 of the frame 140, 140′ and a hole of the hitch 202. Subsequent to engaging the lift 104, 104′ with the vehicle 200, the lift 104, 104′ may be coupled/engaged with the rack 102. For so doing, the bar 164 of the lift 104, 104′ is coupled with the rack 102 by extending the beam 110 of the rack 102 inside the bar 164 and extending a suitable pin through an aligned opening 166 of the bar and a hole of the beam 110.

In some embodiment, before engaging the lift 104, 104′ with the rack 102, the lift structure 160 is moved to the raised position to enable an easy coupling of the bar 164 with the beam 110 of the rack 102. Upon engagement with the rack 102, the lift structure 160 is moved to the lowered position. In an embodiment, at the lowered position of the lift 104, 104′, a ramp or a portion of the loading structure 106 of the rack 102 may contact the ground. Accordingly, by lowering the height of the rack 102 relative to the ground, the lift 104, 104′ enables an easy loading of the cargo, for example, bikes, on the loading structure 106, without using any additional equipment. Further, subsequent to the loading of the cargo on the rack 102, the rack 102 is raised relative to the ground by moving the lift structure 160 to the raised position. Thereafter, the rack 102 along with the lift 104, 104′ is towed behind the vehicle 200 and the cargo is transported from the loading location to the unloading location. To unload the cargo, at the unloading station, the lift structure 160 is again moved to the lowered position to facilitate an easy removal of the cargo from the rack 102 without using any addition equipment.

The above description is given by way of example, and not limitation. Given the above disclosure, one skilled in the art could devise variations that are within the scope and spirit of the disclosure disclosed herein, including various ways of lowering, lifting, and coupling the rack. Further, the various features of the embodiments disclosed herein can be used alone, or in varying combinations with each other and are not intended to be limited to the specific combination described herein. Thus, the scope of the claims is not to be limited by the illustrated embodiments. Further, the mere fact that different features are recited in mutually different dependent or independent claims does not indicate that a combination of these features cannot be advantageously used, such as a combination remaining within the scope of the aspects of the disclosed embodiment.

What is claimed is:

1. A lift, comprising:
a frame configured to be removably coupled to a hitch of a vehicle; and
a lift structure adapted to be coupled to a transport rack and movably coupled to the frame, the lift structure is configured to move in a vertical direction between a raised position and a lowered position relative to the frame,
wherein the lift structure is moved to the lowered position to enable a loading and an unloading of a cargo from the transport rack.

2. The lift of claim 1, wherein the frame includes
at least one column extending in the vertical direction, wherein the lift structure is movably coupled to the at least one column, and
an arm extending perpendicularly to the at least one column and configured to be removably coupled to the hitch of the vehicle.

3. The lift of claim 2, wherein the arm defines at least one hole to facilitate the removable coupling of the arm with the hitch of the vehicle.

4. The lift of claim 2, wherein the at least one column includes
a first column and the arm is attached to the first column, and
a second column attached to the first column and extending parallel to the first column, wherein the lift structure is telescopically coupled to the second column and is adapted to extend and retract relative to second column between the raised position and the lowered position.

5. The lift of claim 1, wherein the lift structure includes
a post extending in the vertical direction and movably coupled to the at least one column, and
an elongated bar extending perpendicularly to the post and configured to engage with the transport rack to facilitate the coupling of the lift and the transport rack.

6. The lift of claim 5, wherein the elongated bar defines at least one opening to facilitate the engagement of the elongated bar with the transport rack.

7. The lift of claim 1 further comprises a pair of extendable ratchet straps attached to the lift structure and a pair of hooks attached to the pair of ratchet straps.

8. The lift of claim 1 further comprising an actuator assembly configured to move the lift structure between the raised position and the lowered position.

9. The lift of claim 8, wherein the actuator assembly includes an actuator and a lift mechanism coupled to the lift structure and operated by the actuator to move the lift structure between the raised position and the lowered position.

10. The lift of claim 9, wherein the actuator includes an electric motor, and the lift further includes a battery configured to power the electric motor.

11. The lift of claim 10 further comprises an on-off switch to electrically connect and disconnect the electric motor and the battery.

12. The lift of claim 10 further comprises a direction control switch adapted to be displaced between a first position and a second position to control a direction of rotation of the electric motor.

13. A transport rack assembly, comprising:
a transport rack having a loading structure adapted to support a cargo and an engagement structure; and
a lift removably coupled to the transport rack and including
a frame configured to be removably coupled to a hitch of a vehicle; and
a lift structure removably coupled to the engagement structure of the transport rack and movably coupled to the frame, the lift structure is configured to move in a vertical direction between a raised position and a lowered position relative to the frame,
wherein the lift structure is moved to the lowered position to enable a loading and an unloading of the cargo from the transport rack.

14. The transport rack assembly of claim 13, wherein the frame includes
at least one column extending in the vertical direction, wherein the lift structure is movably coupled to the at least one column, and
an arm extending perpendicularly to the at least one column and configured to be coupled to the hitch of the vehicle.

15. The transport rack assembly of claim 14, wherein the at least one column includes
a first column and the arm is attached to the first column, and
a second column attached to the first column and extending parallel to the first column, wherein the lift structure is telescopically coupled to the second column and is adapted to extend and retract relative to second column between the raised position and the lowered position.

16. The transport rack assembly of claim 13, wherein the lift structure includes
a post extending in the vertical direction and movably coupled to the at least one column, and
an elongated bar extending perpendicularly to the post and configured to engage with the engagement structure to facilitate the removable coupling of the lift and the transport rack.

17. The transport rack assembly of claim 13, wherein the lift further comprises a pair of extendable ratchet straps attached to the lift structure and a pair of hooks attached to the pair of ratchet straps.

18. The transport rack assembly of claim 13, wherein the lift further comprises an actuator assembly configured to move the lift structure between the raised position and the lowered position.

19. The transport rack assembly of claim 18, wherein the actuator assembly includes an actuator and a lift mechanism coupled to the lift structure and operated by the actuator to move the lift structure between the raised position and the lowered position.

20. The transport rack assembly of claim 19, wherein the lift further comprises a direction control switch adapted to be displaced between a first position and a second position to control a direction of movement of the actuator.
